(19) United States
(12) Patent Application Publication
(10) Pub. No.: US 2021/0232886 A1
(43) Pub. Date: Jul. 29, 2021

(54) DIGITAL BUSINESS CARD SYSTEM

(71) Applicant: Rohan Golding, Aurora, CO (US)

(72) Inventor: Rohan Golding, Aurora, CO (US)

(21) Appl. No.: 17/080,260

(22) Filed: Oct. 26, 2020

Related U.S. Application Data
(60) Provisional application No. 62/964,681, filed on Jan. 23, 2020.

(51) Int. Cl. G06K 19/077; G06F 3/0354; G06F 3/0488

(52) U.S. Cl. CPC G06K 19/07707; G06F 3/0488; G06F 3/03545; G06K 19/07711

(57) ABSTRACT

An electronic digital business card system that includes integrated circuits that store and provide information about a person and their business thereon for easy access and sharing, and includes an electronic digital pen to help organize and access data thereon.

### CROSS-REFERENCE TO RELATED APPLICATION

The present application is related to and claims priority from prior provisional application Ser. No. 62/964,681, filed Jan. 23, 2020 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

The present invention relates generally to the field of electronic or digital business cards.

### 2. Description of the Related Art

Prior art business cards have generally been in the form of paper products handed to one another physically with imprinted information thereon. Other prior art forms of transferring information about oneself have been through electronic social media pages through the internet. However, only a small amount of data can be printed upon paper product versions, and the electronic or digital versions are not fully secure and take more time and effort to access. Therefore, a more convenient and efficient form of transferring information about oneself and an associated business or company has become necessary.

### BRIEF SUMMARY OF THE INVENTION

The general purpose of the present invention, which will be described subsequently in greater detail, is to provide an electronic or digital business card system that includes integrated circuits that store and provide information about a person and their business thereon for easy access, and an electronic or digital pen to help organize and access data thereon as well. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a digital business card system, constructed and operative according to the teachings of the present invention.

FIG. 1 shows a perspective view of the electronic digital business card and electronic digital pen according to the preferred embodiment of the present invention.

FIG. 2 shows a perspective view of the interior electronic components of the electronic digital business card and electronic digital pen according to the preferred embodiment of the present invention.

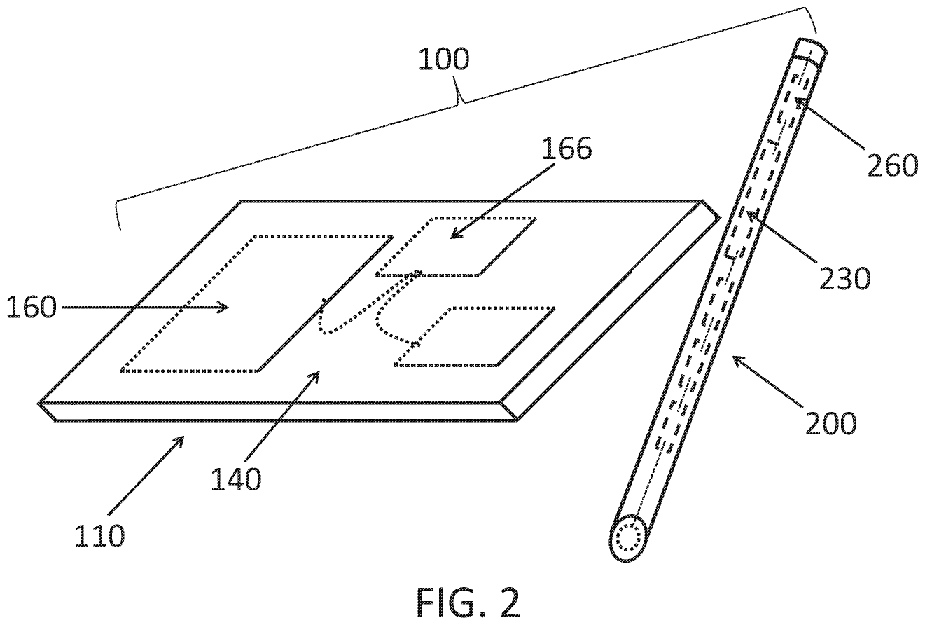

FIG. 3 shows a front view of the electronic digital business card being carried within the wallet of a user according to the preferred embodiment of the present invention.

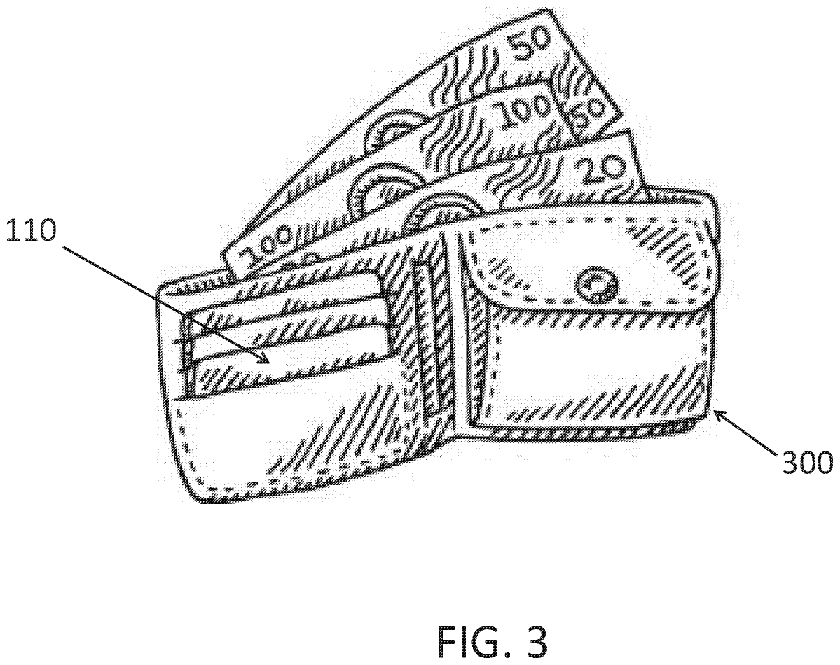

FIG. 4 shows a front view of the electronic digital business card being carried within the pocket of a jacket of a user according to the preferred embodiment of the present invention.

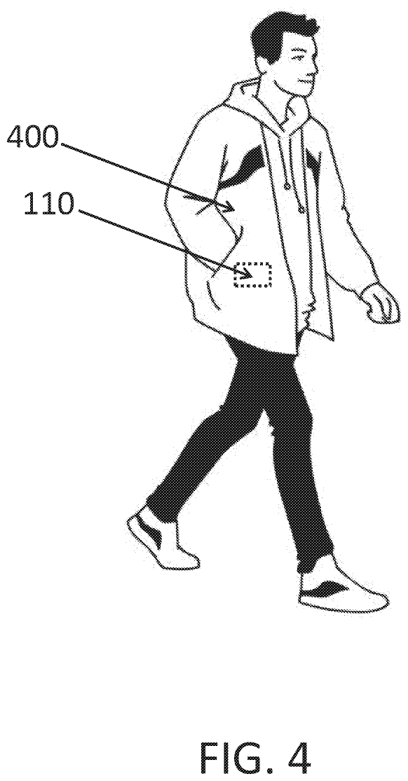

The various embodiments of the present invention will hereinafter be described in conjunction with the appended drawings.

### DETAILED DESCRIPTION

As discussed above, embodiments of the present invention relate to an electronic or digital business card system that includes integrated circuits that store and provide information about a person and their business thereon for easy access, and an electronic or digital pen to help organize and access data thereon as well.

The digital business card system includes a digital business card that may be formed from a plastic material and include a power source, a solar battery back-up, integrated circuits therein forming a computer system, a CD ROM, a receiver, a transmitter, input mechanisms, output mechanisms, a touch-screen visual display, audio speakers, a microphone, a USB port, LED's, and informative indicia thereon. The information stored on the digital business card is adapted to be uploaded to the internet for easy access by others and may include a person's name, business name, personal history, pictures, videos, and the like. Other features and functions can be a play button, a volume button, a fast forward button, a reverse button, and the like. The integrated circuits will be programmed with chosen applications to perform all the functions necessary to operate the system. The digital business card system can be run on the internet, is Wi-Fi capable, and is BLUETOOTH capable. The digital business card system can also be voice activated. The digital business card system can also be directly connected to FACEBOOK, INSTAGRAM, TWITTER, GOOGLE, YAHOO, or BING, and any other social media platform that the user wants to be connected to.

The digital business card system further comprises a digital pen including a computer therein, a power source, a retractable point capable of electronically interacting with the touch-screen visual display of the digital business card, wherein the retractable point is capable of highlighting portions of the touch-screen visual display, a select button, a zoom in button, a zoom out button, a forward button, a reverse/rewind button, all capable of controlling features of the digital business card. The digital pen may be connected to the digital business card through a USB wire or be connected wirelessly.

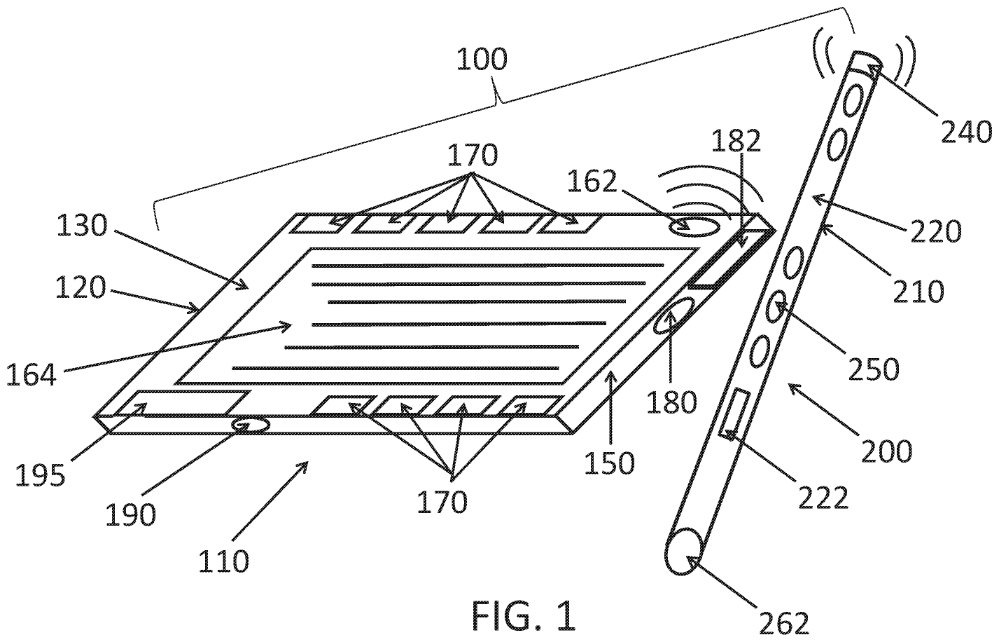

Referring now to the drawings FIG. 1, the digital business card system 100 comprises a digital business card 110 comprising a housing 120 including a top panel 130, a bottom panel 140 spaced from the top panel, at least one side panel 150 connected between the top panel and the bottom panel and forms an enclosed interior volume; a computer 160 including at least one integrated circuit adapted to receive, store, compute, and send information, wherein the computer is located within the interior volume of the housing; a transceiver 162 located within the interior volume of the housing and is electronically connected to the computer; a computer screen 164 attached to an external surface of the top panel, wherein the computer screen includes touch-screen technology adapted to allow a user to control the computer and input information thereto, and wherein the computer screen is adapted to display information from the computer; and a power source 166 located within the interior volume of said housing and is electronically connected to the computer 160, the computer screen 164, and the transceiver and supplies electrical power thereto; and a digital pen 200 comprising a housing 210 including an elongated tube 220 including a proximal end and a distal end, wherein the elongated tube forms an enclosed interior volume; an electronic tip 262 connected to the proximal end of the elongated tube, wherein said electronic tip is adapted to electronically interact with the computer screen of the digital business card; a computer 230 including at least one integrated circuit, wherein the integrated circuit is adapted to receive, store, compute, and send information, wherein the computer is located within the interior volume of the elongated tube; a transceiver 240 located within the interior volume of the elongated tube and is electronically connected to the computer of the digital pen; and at least one control button 250 attached to an external surface of the elongated tube and is electronically connected to the computer of the digital pen and is adapted to provide commands to the computer of the digital pen and to the computer of the digital business card; a power source 260, charged via USB port 222, located within the interior volume of the elongated tube and is electronically connected to the electronic tip, the computer of the digital pen, the transceiver of the digital pen, and the at least one control button, and supplies electrical power thereto, wherein the digital pan is adapted to interact remotely and physically with the digital business card, and provide additional controls for the digital business card, wherein the digital business card system is adapted to be used to send and receive business information of a user to and from another person or to another digital business card system, and wherein the digital business card system is adapted to be used directly between two people or via an external communication system.

The digital business card 110 may further comprise at least one control button 170 attached to an external surface of the at least one side panel, and wherein the at least one control button is electronically connected to the power source of the digital business card and the computer of the digital business card, and is adapted to provide commands to the computer of said digital business card.

The digital business card 110 may further comprise a video camera 180 attached to an external surface of the at least one side panel, and wherein the video camera is electronically connected to the power source of the digital business card and the computer of the digital business card, and is adapted to record video to the computer of the digital business card; a microphone 190 attached to an external surface of the at least one side panel, wherein the microphone is electronically connected to the power source of the digital business card and the computer of the digital business card, and is adapted to record audio to the computer of the digital business card; and a speaker 195 attached to an external surface of the at least one side panel, wherein said speaker is electronically connected to the power source of the digital business card and the computer of the digital business card, and is adapted to play audio from the computer of the digital business card.

The control buttons 170 of the digital business card include a play audio button, a play video button, a rewind audio button, a rewind video button, a pause audio button, a pause video button, an increase audio volume button, and a decrease audio volume button.

The digital business card 110 may be sized and shaped to fit within a pocket of a user's personal clothing 400 or within a wallet 300 of a user. Furthermore, the computer screen 164 is also adapted to be controlled via human touch.

In use, the digital business card 110 is adapted for a user to upload data, video, and audio pertaining to their business and/or employment, personal and contact information, and other data deemed appropriate via transceivers 162 and 240, a USB port 182, and/or the video camera 180 and microphone 190. The digital pen 200 can be used via contact between the electronic tip 262 and the computer screen 164 of the business card 110 or via transceivers 162 and 240. The control buttons of the digital pen 200 can also be used to control the digital business card 110 via transceivers 162 and 240. The user can then carry the digital business card 110 and the digital pen 200 in their wallet, purse, or pockets of their clothing. Then when the user wants to share their information with another person they can either hand over their digital business card 110 to that person or transfer chosen information via transceiver 162 to the other person's personal computer device. Furthermore, when the user wants to retrieve another person's information they can do so via transceiver 162 as well.

The integrated circuit of the computer 160 may be formed as a silicon integrated chip. The computer 160 is further adapted to store and process varying types and sizes of computer applications. As such, the digital business card 110 can communicate with external communication systems, including internet and intranet systems. In following, the digital business card 110 can connect with and transfer information from and to FACEBOOK, INSTAGRAM, TWITTER, YOUTUBE, and any other social media platforms. Further, it can be used to transfer payments through the internet via websites such as GOOGLE PAY, CASH APP, PAYPAL, ZELLE, etc. Furthermore, the microphone 190 and computer 160 can be used to control the digital business card 110 via voice commands.

The computer screen 164 can be formed from liquid crystal diodes (an LCD screen). Light emitting diodes (LEDs) can also be incorporated to light up the computer screen in the dark. The rechargeable batteries of both the digital business card 110 and the digital pen 200 can be charged via USB ports 182 and 222 respectively, and/or be charged via a solar panel or flat charger.

The electronic tip of the digital pen 200 may be retractable and formed from an electronic sensitive material. Further, it has the ability to highlight sections of the computer screen 164 of the digital business card 110. Furthermore, the controls on the digital pen 200 can also control the actions of the digital business card including a play audio button, a play video button, a rewind audio button, a rewind video button, a pause audio button, a pause video button, an increase audio volume button, and a decrease audio volume button.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A digital business card system comprising:
a digital business card comprising:
a housing including:
a top panel;
a bottom panel;
wherein said bottom panel is spaced from said top panel;
at least one side panel;
wherein said at least one side panel is connected between said top panel and said bottom panel;
wherein said top panel, said bottom panel, and said at least one side panel form an enclosed interior volume;
a computer including:
at least one integrated circuit;
wherein said integrated circuit is adapted to receive, store, compute, and send information;
wherein said computer is located within said interior volume of said housing;
a transceiver;
wherein said transceiver is located within said interior volume of said housing and is electronically connected to said computer;
a computer screen;
wherein said computer screen is attached to an external surface of said top panel;
wherein said computer screen includes touch-screen technology adapted to allow a user to control said computer and input information thereto; and
wherein said computer screen is adapted to display information from said computer; and
a power source;
wherein said power source is located within said interior volume of said housing and is electronically connected to said computer, said computer screen, and said transceiver and supplies electrical power thereto; and
a digital pen comprising:
a housing including:
an elongated tube including:
a proximal end; and
a distal end;
wherein said elongated tube forms an enclosed interior volume;
an electronic tip;
wherein said electronic tip is connected to said proximal end of said elongated tube; and
wherein said electronic tip is adapted to electronically interact with said computer screen of said digital business card;
a computer including:
at least one integrated circuit;
wherein said integrated circuit is adapted to receive, store, compute, and send information;
wherein said computer is located within said interior volume of said elongated tube;
a transceiver;
wherein said transceiver is located within said interior volume of said elongated tube and is electronically connected to said computer of said digital pen;
at least one control button;
wherein said at least one control button is attached to an external surface of said elongated tube; and
wherein said at least one control button is electronically connected to said computer of said digital pen and is adapted to provide commands to said computer of said digital pen and to said computer of said digital business card;
a power source;
wherein said power source is located within said interior volume of said elongated tube and is electronically connected to said electronic tip, said computer of said digital pen, said transceiver of said digital pen, and said at least one control button, and supplies electrical power thereto;
wherein said digital pan is adapted to interact remotely and physically with said digital business card, and provide additional controls for said digital business card;
wherein said digital business card system is adapted to be used to send and receive business information of a user to and from another person or to another digital business card system; and
wherein said digital business card system is adapted to be used directly between two people or via an external communication system.

2. The digital business card system of claim 1, wherein said digital business card further comprises:
at least one control button;
wherein said at least one control button is attached to an external surface of said at least one side panel; and
wherein said at least one control button is electronically connected to said power source of said digital business card and said computer of said digital business card, and is adapted to provide commands to said computer of said digital business card.

3. The digital business card system of claim 2, wherein said digital business card further comprises:
a video camera;
wherein said video camera is attached to an external surface of said at least one side panel; and
wherein said video camera is electronically connected to said power source of said digital business card and said computer of said digital business card, and is adapted to record video to said computer of said digital business card;
a microphone;
wherein said microphone is attached to an external surface of said at least one side panel; and
wherein said microphone is electronically connected to said power source of said digital business card and said computer of said digital business card, and is adapted to record audio to said computer of said digital business card; and
a speaker;
wherein said speaker is attached to an external surface of said at least one side panel; and
wherein said speaker is electronically connected to said power source of said digital business card and said computer of said digital business card, and is adapted to play audio from said computer of said digital business card.

4. The digital business card system of claim 3, wherein said at least one control button is chosen from a list of control buttons consisting of play audio, play video, rewind audio, rewind video, pause audio, pause video, increase volume of said audio, and decrease volume of said audio.

10. The digital business card system of claim 1, wherein said digital business card is sized and shaped to fit within a pocket of a user's personal clothing.

11. The digital business card system of claim 1, wherein said digital business card is sized and shaped to fit within a wallet of a user.
